(19) United States
(12) Patent Application Publication
(10) Pub. No.: US 2025/0391105 A1
(43) Pub. Date: Dec. 25, 2025

(54) Systems and Methods for Adaptive Point Cloud Distribution

(71) Applicant: Illuscio, Inc., Culver City, CA (US)

(72) Inventor: Thomas Matterson, Breaker Bay (NZ)

(73) Assignee: Illuscio, Inc., Culver City, CA (US)

(21) Appl. No.: 18/748,874

(22) Filed: Jun. 20, 2024

(51) Int. Cl. G06T 17/00; H04N 19/597

(52) U.S. Cl. CPC G06T 17/00; H04N 19/597

(57) ABSTRACT

A distribution system adaptively provides different lossy encodings for different views of a point cloud to a client device based on network or rendering performance of the client device. The distribution system receives a request to access the point cloud, and determines the one or more performance parameters that limit an amount of the point cloud data that the client device is able to receive or process in a given time. The distribution system selects and provides the client device with different sets of optimized splats for different views of the point cloud that satisfy the one or more performance parameters based on a cumulative amount of data encoded within the different sets of optimized splats being equal to or less than the amount of point cloud data that the client device is able to receive or process in the given time.

### BACKGROUND

A point cloud may be defined with a set of points that are distributed across a three-dimensional space (3D). The set of points form a 3D representation or 3D model of one or more objects, scenes, or environments when rendered in the 3D space at their defined positions with their defined visual characteristics. Million or billions of points may be defined to accurately represent the structures, shapes, visual characteristics, and/or other properties of the 3D representation or the 3D model at a resolution or density that is sufficient to eliminate gaps or other visual discontinuity between the points.

Each point cloud point may be defined with at least a position in the 3D space (e.g., x, y, and z coordinates) and at least one parameter for visually representing the point at the defined position (e.g., color, roughness, transparency, reflectivity, etc.). As a result, the size or amount of data encoded within a single point cloud may be several orders of magnitude larger than two-dimensional (2D) images or other 3D formats that represent the same 3D representation or 3D model with polygons or meshes that are larger than and span larger regions of space than a single point of the point cloud.

The larger size and greater amount of data stored within a point cloud relative to 2D images and other 3D formats cause point clouds to be a less desirable format for streaming and/or processing. Specifically, greater bandwidth and hardware resources are needed to stream and render a point cloud relative to other formats. Accordingly, there is need to reduce the amount of data that is defined within a point cloud without significant loss in the visual quality.

### BRIEF DESCRIPTION OF THE DRAWINGS

FIG. 1 illustrates an example of adaptive point cloud distribution based on dynamically selected optimized splats in accordance with some embodiments presented herein.

FIG. 2 illustrates examples of optimized splats that represent different lossy encodings of different visual characteristics for different views of a point cloud in accordance with some embodiments presented herein.

FIG. 3 presents a process for streaming dynamically selected combinations of optimized splats to adapt a point cloud to different network performance in accordance with some embodiments presented herein.

FIG. 4 presents a process for adaptive optimized splat distribution based on device performance in accordance with some embodiments presented herein.

FIG. 5 illustrates an example of the adaptive distribution of optimized splats for a point cloud based on different prioritizations of the point cloud visual characteristics in accordance with some embodiments presented herein.

FIG. 6 presents a process for rendering a 3D visualization from different sets of optimized splats that are encoded with different amounts of data for different visual characteristics in the same views in accordance with some embodiments presented herein.

FIG. 7 illustrates example components of one or more devices, according to one or more embodiments described herein.

### DETAILED DESCRIPTION OF PREFERRED EMBODIMENTS

The following detailed description refers to the accompanying drawings. The same reference numbers in different drawings may identify the same or similar elements.

Disclosed are systems and associated methods for adaptive point cloud distribution. The adaptive point cloud streaming and processing involves dynamically selecting different lossy encodings for different visual characteristics in different views of the point cloud to provide to a client device based on network performance and/or performance of the client device. The lossy encodings for each view may be rendered to generate a visualization for the features or surfaces represented by the points of the point cloud in that view, and the visualizations generated for each view may be combined to produce a complete three-dimensional (3D) visualization of the point cloud.

Each lossy encoding may be defined with a reduced set of primitives relative to the number of points from the original point cloud that are defined in the view represented by the lossy encoding. The reduced set of primitives for a particular lossy encoding eliminates redundant definitions of neighboring or adjacent points with the same one or more visual characteristics. In other words, the definition of two or more neighboring or adjacent points in the point cloud having the same values for the same visual characteristics may be replaced by the definition of a single replacement primitive in the lossy encoding that spans the positions of the two or more neighboring or adjacent points and that has the same values for the same visual characteristics.

In some embodiments, the lossy encodings correspond to two or more optimized splats that are generated for each of several views of the point cloud that collectively represent or recreate the entire 3D space of the point cloud. Each optimized splat may be defined with a different reduced set of primitives for one or more visual characteristics that have the same or similar variation across the original points from the point cloud in that view. In other words, different optimized splats may be generated and stored for the same visual characteristics and the same view with each of different optimized splats representing those visual characteristics and that view with a different amount of data reduction and loss.

A point cloud distribution system may receive a request to access a particular point cloud. The point cloud distribution system may analyze network performance, rendering performing of the device issuing the request, and/or a prioritization of visual characteristics specified in the request, and may select a combination of optimized splats based on one or more of the network performance, rendering performance, or desired visual characteristics. Specifically, the point cloud distribution system may select a combination of optimized splats that encode or represent the point cloud with a reduced amount of data that may be streamed to the requesting device in real-time or a specific time frame given the network performance, that may be rendered by the requesting device at a particular frame rate given the rendering performance, and/or that preserves quality while reducing the total amount of data according to the prioritization of the visual characteristics.

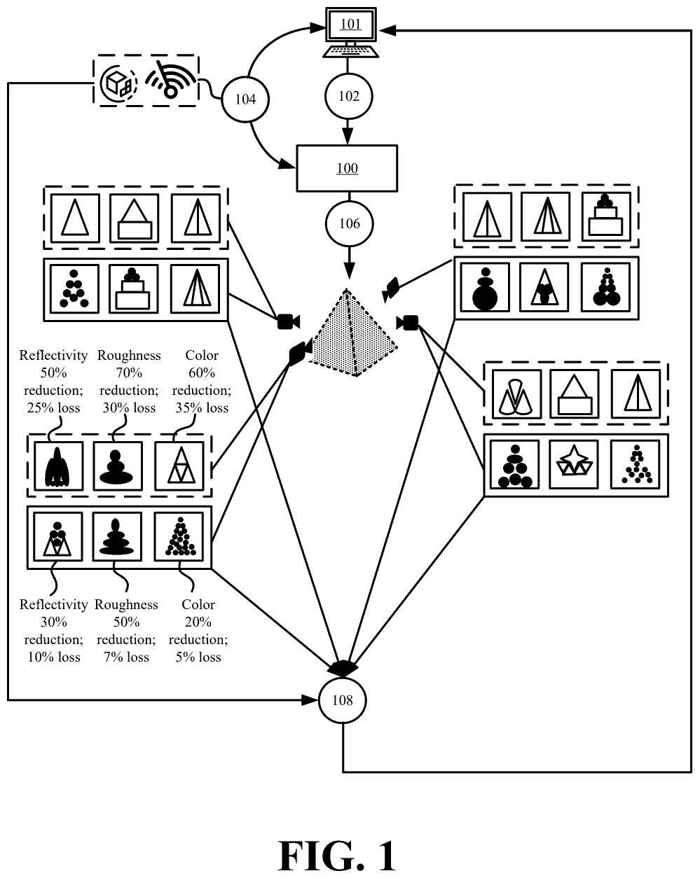

FIG. 1 illustrates an example of adaptive point cloud distribution based on dynamically selected optimized splats in accordance with some embodiments presented herein. Point cloud distribution system 100 receives (at 102) a request for a particular point cloud from device 101 over a data network. The request may be issued as a HyperText Transfer Protocol (HTTP) GET message or a request message in the format of another networking protocol. The request may identify the name of the particular point cloud or a link that is used to access the particular point cloud.

Point cloud distribution system 100 monitors (at 104) one or more parameters affecting the rate at which device 101 receives, renders, and/or otherwise processes the point cloud data. For instance, point cloud distribution system 100 monitors (at 104) the available bandwidth along the network path to device 101, latency, jitter, and/or packet loss that affect how much point cloud data device 101 is able to receive from point cloud distribution system 100 at a given time which limits what device 101 is able to render in real-time or at a particular frame rate (e.g., 30 frames per second). point cloud distribution system 100 may also monitor (at 104) the rendering performance of device 101. The rendering performance may be a measure of the number of points or primitives and/or the number of visual characteristics that device 101 is able to render at the particular frame rate.

Point cloud distribution system 100 retrieves (at 106) the optimized splats that have been generated for the particular point cloud. The optimized splats are different lossy encodings or representations for different visual characteristics of the point cloud points found in different views of the particular point cloud. For instance, the different optimized splats may be generated for the front, left, right, and back views of the particular point cloud. The different optimized splats for the front view may include a first set of two or more optimized splats that encode the values defined for the color visual characteristics (e.g., red, green, and blue color values) of the points in the corresponding front view with different amounts of data reduction and quality loss (e.g., a first optimized splat that encodes the color visual characteristics in the front view with 5,000 primitives with a 90% color accuracy or 10% loss, and a second optimized splat that encodes the color visual characteristics in the front with 3,000 primitives with an 87% color accuracy or 13% loss), a second set of two or more optimized splats that encode the reflectivity values of the points in the corresponding front view with different amounts of data reduction and quality loss, and a third set of two or more optimized splats that encode two or more other visual characteristics of the points in the corresponding front view with different amounts of data reduction and quality loss. In some embodiments, point cloud distribution system 100 generates and stores different optimized splats for N views of the particular point cloud, wherein the N views capture the entire 3D space of the particular point cloud with sufficient overlap between neighboring views to allow for aligning and combining the views to form the 360-degree representation of the 3D space.

Different splatting techniques may be used to generate the optimized splats and reduce the data associated with each view of the particular point cloud. In generating the optimized splats, the splatting techniques may eliminate the data associated with points that are obscured or not visible from the corresponding view (e.g., obscured points that are positioned behind other points and therefore do not contribute to the visualization of the particular point cloud from that view). In generating the optimized splats, the splatting techniques may replace the data associated with two or more neighboring points having the same visual characteristic values with the definition of a single replacement primitive that spans the positions of the two or more neighboring points or that approximates the shape formed by the two or more neighboring points.

Point cloud distribution system 100 selects (at 108) a combination of optimized splats for a complete lossy 3D representation of the particular point cloud with a minimal amount of loss that device 101 is able to receive, render, and/or otherwise processes in a specified time or at a particular rate with the one or more monitored (at 104) parameters affecting the rate at which device 101 receives, renders, and/or otherwise processes the point cloud data. For instance, point cloud distribution system 100 selects (at 108) a set of optimized splats that represents a lossy encoding of all visual characteristics defined for the points of the particular point cloud in each of the views needed to reconstruct the complete lossy 3D representation with the total amount of data encoded to the selected (at 108) set of optimized splats being equal to or less than the available bandwidth for real-time transmission to device 101 (e.g., available bandwidth for streaming the lossy 3D representation at 30 frames per second to device 101). More specifically, the selected (at 108) combination of optimized splats may include a first optimized splat encoding a lossy representation of a first visual characteristic in the front view with a first amount of data reduction and loss, a second optimized splat encoding a lossy representation of second and third visual characteristics in the front view with a second amount of data reduction and loss, a third optimized splat encoding a lossy representation of the first visual characteristic in the left view with a third amount of data reduction and loss, a fourth optimized splat encoding a lossy representation of the second and third visual characteristics in the left view with a fourth amount of data reduction and loss, a fifth optimized splat encoding a lossy representation of the first visual characteristic in the back view with a fifth amount of data reduction and loss, a sixth optimized splat encoding a lossy representation of the second and third visual characteristics in the back view with a sixth amount of data reduction and loss, a seventh optimized splat encoding a lossy representation of the first visual characteristic in the right view with a seventh amount of data reduction and loss, and an eight optimized splat encoding a lossy representation of the second and third visual characteristics in the right view with an eight amount of data reduction and loss. In this example, the first, second, and third visual characteristics represent all the visual characteristics that are defined for the points of the point cloud, and the front, left, back, and right views collectively produce a 360-degree or continuous lossy representation of the particular point cloud.

Point cloud distribution system 100 provides the selected (at 108) combination of optimized splats to device 101 in response to the request. Device 101 generates the 360-degree lossy representation of the particular point cloud by rendering each of the streamed (at 110) optimized splats and combining the visualization produced by the subset of optimized splats selected for each view into a single 3D visualization.

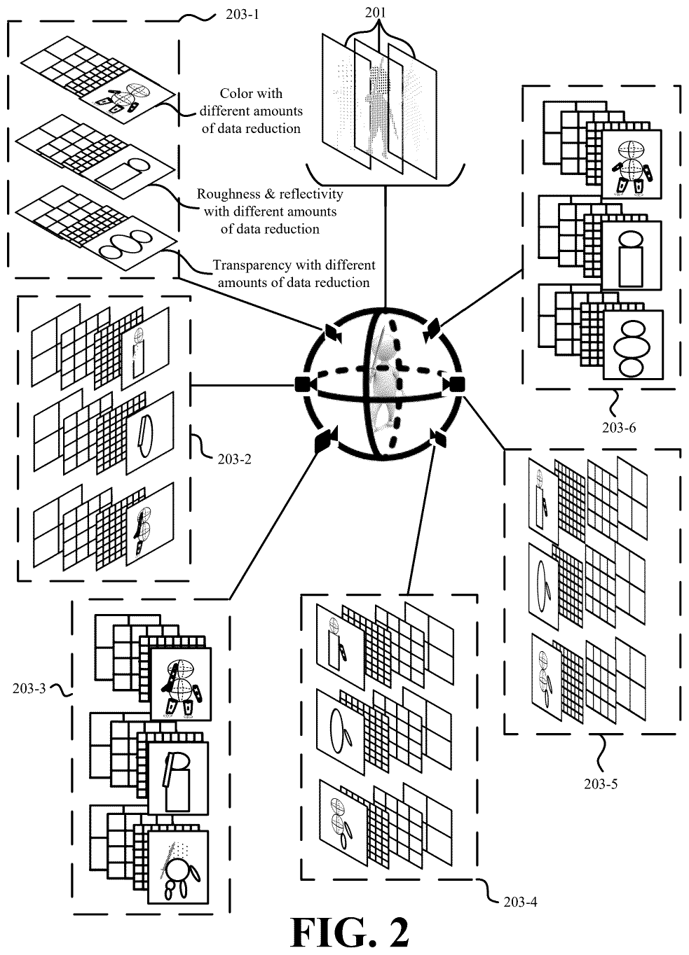

FIG. 2 illustrates examples of optimized splats that represent different lossy encodings of different visual characteristics for different views of a point cloud 201 in accordance with some embodiments presented herein. The optimized splats are defined from six different views 203-1, 203-2, 203-3, 203-4, 203-5, and 203-6 (hereinafter collectively referred to as “views 203” or individually referred to as “view 203”) of point cloud 201 that collectively encompass or capture all points of point cloud 201.

Each view 203 includes different sets of optimized splats with each of the different sets of optimized splats encoding a different visual characteristic of the point cloud 201 points in that view 203 with a different reduced set of primitives. Accordingly, each set of optimized splats in a particular view 203 defines the different visual characteristics in that particular view 203 with different amounts of data reduction and loss.

For instance, first view 203-1 includes three different sets of optimized splats. The first set of optimized splats of first view 203-1 may include a first optimized splat that encodes the color visual characteristic for the points in first view 203-1 with a first set of reduced primitives and a first amount of data reduction, a second optimized splat that encodes the color visual characteristic for the points in first view 203-1 with a second set of reduced primitives and a second amount of data reduction, a third optimized splat that encodes the color visual characteristic for the points in first view 203-1 with a third set of reduced primitives and a third amount of data reduction, and a fourth optimized splat that encodes the color visual characteristic for the points in first view 203-1 with a fourth set of reduced primitives and a fourth amount of data reduction. More specifically, the fourth optimized splat may have fewer and larger replacement primitives than the first, second, and third optimized splats and may represent the color visual characteristic in first view 203-1 with less data and less visual accuracy or quality than the third optimized splat with more and smaller replacement primitives. The second set of optimized splats of first view 203-1 may include different optimized splats encoding the roughness and the reflectivity visual characteristics for the points in first view 203-1 with different reduced sets of primitives and different amounts of data reduction, and the third set of optimized splats of first view 203-1 may include different optimized splats encoding the transparency visual characteristic for the points in first view 203-1 with different reduced sets of primitives and different amounts of data reduction.

The multiple optimized splats for the same view 203 and for the same visual characteristic are generated to accommodate and support streaming over network paths with different performance, processing by devices with different resources (e.g., hardware, processing, rendering, etc.), and/or requests from devices that prioritize certain visual characteristics over others (e.g., highest color accuracy and lowest reflectivity accuracy). In some embodiments, the optimized splats are generated and stored by point cloud distribution system 100 or another optimization or compression system prior to receiving requests for access to point cloud 201.

The optimized splats may be generated using various adapted splatting techniques. The adapted splatting techniques may use Neural Radiance Fields (NeRFs), decimation-based data reduction, and/or other primitive swapping to generate the points and/or primitives of the optimized splats and to achieve different amounts of data reduction with different amounts of quality or fidelity loss.

For instance, each point of point cloud 201 may be defined with a position in a 3D space and with two or more visual characteristics for visualizing that point at the defined position. The visual characteristics may include a color (that is defined with red, green, blue, and/or other values), chrominance, hardness, translucence, reflectivity, luminance, metallic characteristics, roughness, specular, diffuse, albedo, index of refraction (IOR), and/or other properties of a surface, feature, or article represented by the point at the corresponding position in the 3D space. An optimized splat reduces the amount of data that is used to encode values of one or more visual characteristics in a particular view of point cloud 201 by eliminating redundant definitions of points having the same or similar values for the one or more visual characteristics.

In some embodiments, an optimized splat eliminates redundant definitions of points by removing partially or wholly obscured points from the optimized splat. For instance, the position of a first point may partially overlap with the position of a second point with the second point being positioned in front of the first point when presented from a particular view. One or more neural networks may identify the overlapping positions, may identify that the first point and the second point are defined with the same visual characteristic value, and may generate the optimized splat to retain the second point and remove all data associated with the first point from the optimized splat.

In some embodiments, an optimized splat eliminates redundant definitions of points by replacing a set of two or more neighboring or adjacent points that have the same or similar visual characteristic values with a replacement primitive that has a shape spanning the position of each point from the set of two or more neighboring or adjacent points or that has a form that approximates a shape formed by the set of two or more neighboring or adjacent points. The replacement primitive is also defined with the visual characteristic values of the two or more neighboring or adjacent points. In other words, the definition of the set of two or more neighboring or adjacent points is replaced with a definition of a single replacement primitive. In some embodiments, the replacement primitive may be defined as a point with an enlarged size, an ellipse, a polygon, or other primitive that spans a larger region of the 3D space than the individual points of the point cloud being replace. For instance, the definition of the replacement primitive may include an x, y, and z coordinate for a center of the replacement primitive, and one or more radii to specify different distances that the shape of the replacement primitive extends from the center in different axes.

The ratio of the data reduction to quality loss is maximized (e.g., more data reduction with less quality loss) in an optimized splat when the visual characteristic that is optimized by that optimized splat has a low variance or when the points in the optimized view are defined with the same or similar values (e.g., values that differ by less than a threshold amount). In some embodiments, an optimized splat may be generated to represent values of two or more visual characteristics. For instance, the points in a particular view of the point cloud may represent different objects with uniform material properties. As such, the points for each represented object may be defined with the same roughness, reflectivity, and transparency. Rather than generate and store a different optimized splat for each of the roughness, reflectivity, and transparency visual characteristics, the neural networks may determine that the different sets of points representing the different objects are defined with the same values for the roughness, reflectivity, and transparency visual characteristics, and may therefore generate a single optimized splat with a replacement primitive replacing each of the different sets of points and with each replacement primitive being defined with a single set of values for the roughness, reflectivity, and transparency visual characteristics.

The adapted splatting techniques used to generate the optimized splats may be based on an existing splatting technique (e.g., Gaussian Splatting) that is modified to receive the original point cloud as input rather than a set of 2D images that capture an object from different views or angles. In other words, the adapted splatting techniques generate the optimized splats based on the 3D positioning of different visual parameters in the 3D space of the original point cloud rather than creating a five-dimensional (5D) coordinate system or radiance field from an aligned set of 2D images. The adapted splatting techniques are also modified to include a 3D rendering pipeline for comparing 3D visualizations of the different visual characteristics between the original point cloud and the corresponding one or more optimized splats that are generated for those different visual characteristics, and a modified loss function for retraining the neural networks and adjusting the optimized splat generation based on the results of the comparisons.

Each optimized splat may include one or more identifiers or metadata to differentiate that optimized splat from other optimized splats belonging to the same point cloud. The identifiers or metadata for a particular optimized splat may indicate which visual characteristics are encoded by that particular optimized splat, the view associated with the particular optimized splat or the position of the view represented by the particular optimized splat in the 3D space of the point cloud, the data reduction or size, and/or the loss associated with the visual characteristics that are defined by the reduced set of primitives of the particular optimized splat. For instance, a first identifier may specify which of the color, chrominance, hardness, translucence, reflectivity, luminance, metallic characteristics, roughness, specular, diffuse, albedo, IOR, and/or other visual characteristics are represented or defined by the primitives of the optimized splat. A second identifier may identify the position in a 3D space at which the primitives of the optimized splat are to be rendered in order to generate a visualization for a represented view in the overall or combined 3D visualization. A third identifier may identify the size or amount of data contained in the optimized splat, and a fourth identifier may specify a value that quantifies an amount of loss in visual quality between the visual characteristics of an original set of points from the point cloud and the visual characteristics of the optimized splat that are a lossy representation of the visual characteristics of the original set of points.

The lossy encoding of the different views in the different sets of optimized splats that are created for a point cloud collectively recreate or represent the 3D space of the point cloud or a 360-degree representation of the visual elements defined in the point cloud. Different views or different numbers of views may be used to generate different lossy representations of a point cloud. For instance, a point cloud may be optimized with a first amount of data reduction and loss by generating optimized splats at 90-degree positional offsets (e.g., front, left, back, and right views), and the same point cloud may be optimized with a second amount of data reduction and loss by generating optimized splats at 30-degree positional offsets or by generating optimized splats for the different sets of points that come into a field-of-view that is established at every 30 degrees around the points of the point cloud.

Point cloud distribution system 100 may select a different subset of optimized splats for each view that encodes all the visual characteristics or a requested set of visual characteristics in that view, and may provide the selected subsets of optimized splats to a requesting device. However, rather than provide the same optimized splats in response to every request to access the same point cloud, point cloud distribution system 100 may mix-and-match different optimized splats for different visual characteristics and different views in order to provide a lossy representation or encoding of the point cloud with a dynamically customized amount of data reduction and loss that accommodates, satisfies, or best adheres to performance constraints associated with each client device receiving and/or rendering the optimized splats. In particular, point cloud distribution system 100 may mix-and-match the different optimized splats according to different network performance, different processing or rendering performance by devices with different capabilities and/or resources, and/or requests that prioritize different visual characteristics.

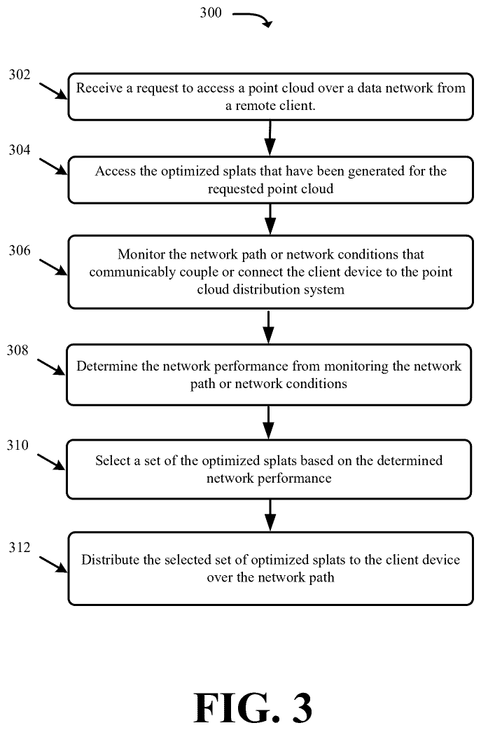

FIG. 3 presents a process 300 for streaming dynamically selected combinations of optimized splats to adapt a point cloud to different network performance in accordance with some embodiments presented herein. Process 300 is implemented by point cloud distribution system 100.

In some embodiments, point cloud distribution system 100 includes one or more devices or machines with processor, memory, storage, network, and/or other hardware resources that are adapted for or configured to distribute point clouds and/or other content to requesting devices over a data network. For instance, point cloud distribution system 100 may correspond to a media server of a content delivery platform or streaming service provider from which users access different 3D content that are encoded as point clouds.

Process 300 includes receiving (at 302) a request to access a point cloud over the data network from a remote client. The data network may correspond to a broadband network, wireless telecommunications network (e.g., Long-Term Evolution (4G) network or Fifth Generation (5G) network), or other data network that transfers data via message or packet formats of one or more network protocols. The request may include an identifier that identifies the requested point cloud.

In some embodiments, the points of the requested point cloud may represent one or more 3D objects, scenes, or environments. In some other embodiments, the points of the requested point cloud may encode a frame in a 3D animation, video, or game.

Process 300 includes accessing (at 304) the optimized splats that have been generated for the requested point cloud. The optimized splats are defined with the different reduced sets of primitives that encode different visual characteristics of points in different views of the point cloud with different amounts of data reduction and loss. More specifically, the optimized splats provide multiple encodings for the same one or more visual characteristics in the same view with different numbers of primitives in different shapes and sizes for different amounts of data reduction and/or loss. Each optimized splat may be associated with one or more identifiers or metadata that specify the data reduction or file size associated with that optimized splat, the visual characteristics encoded to that optimized splat, and an amount of loss associated with the encoded visual characteristics.

Accessing (at 304) the optimized splats may include accessing the folder, repository, memory, or storage where the file or files associated with optimized splats are stored. Point cloud distribution system 100 may use an identifier that identifies the requested point cloud to locate and/or access (at 304) the storage location where the different optimized splats are stored.

Process 300 includes monitoring (at 306) the network path or network conditions that communicably couple or connect the client device to point cloud distribution system 100. Monitoring (at 306) the network path may include measuring bandwidth, congestion, and/or other metrics of the network path, and obtaining one or more of a bandwidth measurement, a latency measurement, and a packet or frame loss measurement.

Process 300 includes determining (at 308) the network performance from monitoring (at 306) the network path or network conditions. Determining (at 308) the network performance may include determining an amount of data or a quality with which the requested point cloud may be distributed to the client device without buffering or in a given amount of time. In some embodiments, determining (at 308) the network performance includes determining an amount of data that can be sent across the network path in order for the client device to render the requested point cloud and/or other point clouds at a particular rate.

Process 300 includes selecting (at 310) a set of the optimized splats based on the determined (at 308) network performance. The set of optimized splats collectively produce a complete visualization of the point cloud with a cumulative size or total amount of data that may be transmitted without delay to the client device given the determined (at 308) network performance. Specifically, the set of optimized splats may include optimized splats that encode all visual characteristics in each view with different amounts of data reduction and/or loss that cumulatively do not exceed the available bandwidth of the monitoring (at 306) network path. For example, point cloud distribution system 100 may select (at 310) a first set of optimized splats for the visual characteristics in each view that have a cumulative size that is less than 100 megabytes (MB) when the network performance is determined (at 308) to be at least 100 MB per second (MBps), and may select (at 310) a different set of optimized splats for the visual characteristics in each view that have a cumulative size that is less than 10 MB when the network performance is determined (at 308) to be at least 10 MBps. As another example, the requested point cloud may correspond to a single frame in an animation that is rendered at 10 frames per second. The client device may request 10 different point clouds every second in order to render the animation. If the determined (at 308) network performance indicates a transfer rate of 100 MBps, then point cloud distribution system 100 selects the set of optimized splats to collectively provide a lossy encoding of the requested point cloud that does not exceed 10 MB. Accordingly

In some embodiments, point cloud distribution system 100 selects (at 310) the set of optimized splats to include splats that are encoded with a similar number of points or primitives (e.g., less than 10% variation in the number of points or primitives between each of the selected optimized splats), a similar amount of encoded data (e.g., less than a 1 MB difference in the encoded data between each of the selected optimized splats), and/or a similar amount of quality or fidelity loss. This ensures that the visual characteristics in the different views are encoded consistently without significant visual difference such that the resulting 3D visualization from combining the views has a consistent quality or level-of-detail throughout. Specifically, the selected (at 310) set of optimized splats encode different visual characteristics at a consistent level-of-detail and/or quality, encode the same visual characteristics consistently in different views, and encode the different view consistently with similar amounts of data and/or similar amounts of loss.

Process 300 includes distributing (at 312) the selected (at 310) set of optimized splats to the client device over the network path. In some embodiments, point cloud distribution system 100 prioritizes the distribution (at 312) of the selected (at 310) set of optimized splats based on an initial field-of-view from which the client device renders the point cloud. For instance, the request may specify a position and/or orientation for a virtual camera or another definition for setting the initial field-of-view. Alternatively, the requested point cloud may be defined with a default initial field-of-view (e.g., a front centered view) at which the point cloud is initially presented. In this instance, point cloud distribution system 100 streams a first subset of optimized splats from the selected (at 310) set of optimized splats that encode the visual characteristics for the view corresponding to the initial field-of-view before streaming other subsets of optimized splats that encode the visual characteristics for other surrounding views.

Point cloud distribution system 100 may adjust the optimized splat selection to account for other criteria that limit the client device's ability to receive, process, and/or render the point cloud. For instance, the hardware and/or software resources of the client device may be unable to render all points of the requested point cloud at a given frame rate (e.g., 30 frames per second).

In some embodiments, the rendering performance of the client device may be limited because of outdated hardware or lower-performing hardware (e.g., underpowered graphics processing unit (GPU)). In some other embodiments, the rendering performance may be limited because the hardware resources of the client device are consumed for other tasks (e.g., physics calculation, collision detection, non-playable character movements, etc.). Moreover, the hardware and/or software resources of the client may be unable to process or render certain visual characteristics (e.g., reflectivity) or may not support certain visual characteristics. Accordingly, point cloud distribution system 100 may dynamically adjust the optimized splats that are provided to the client device based on the processing or rendering performance of the client device.

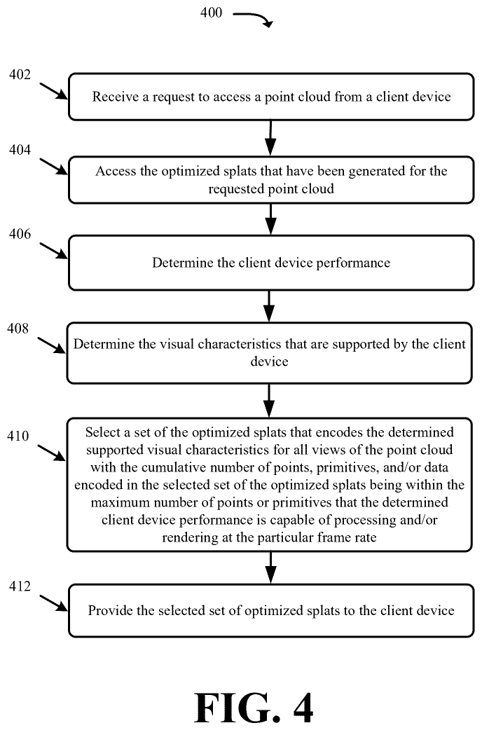

FIG. 4 presents a process 400 for adaptive optimized splat distribution based on device performance in accordance with some embodiments presented herein. Process 400 is implemented by point cloud distribution system 100.

Process 400 includes receiving (at 402) a request to access a point cloud from a client device. In some embodiments, point cloud distribution system 100 runs locally on the client device or is instantiated on the client device as a result of the issued request. For instance, the client device may execute a command to load the requested point cloud, and point cloud distribution system 100 may be instantiated as a result of the executed command to dynamically select the optimized splats that may be seamlessly or smoothly rendered at a particular frame rate on the client device. In some other embodiments, point cloud distribution system 100 is separate and remote from the client device. In some such embodiments, the client device may request to download a lossy representation of the point cloud for subsequent access that may be smoothly rendered at a particular frame rate using the available resources of the client device. In this scenario, the network performance (e.g., bandwidth, latency, etc.) is not a limiting factor in the quality of the point cloud that is provided to the client device since the download is not time constrained.

Process 400 includes accessing (at 404) the optimized splats that have been generated for the requested point cloud. Here again, the optimized splats correspond to different lossy encodings for different visual characteristics from different views of the point cloud. For instance, the optimized splats include a first lossy encoding that is generated for a first visual characteristic in a first view of the point cloud based on the variance of the first visual characteristic in the first view, a second lossy encoding that is generated for second and third visual characteristics in the first view based on the variance of the second and third visual characteristics in the first view, a third lossy encoding that is generated for the first visual characteristic in a second view of the point cloud based on the variance of the first visual characteristic in the second view, a fourth lossy encoding that is generated for the second and third visual characteristics in the second view based on the variance of the second and third visual characteristics in the second view, and so on.

Process 400 includes determining (at 406) the client device performance. In some embodiments, point cloud distribution system 100 may indirectly determine (at 406) the client device performance by identifying the hardware resources that are present and available on the client device for graphics processing and/or rendering. For instance, point cloud distribution system 100 may identify the one or more central processing units (CPUs) and GPUs of the client device as well as the amount of available memory and memory speed. The hardware identification may be included in the request issued by the client device (e.g., in the user-agent or other header fields of the request packets) or may be provided after point cloud distribution system 100 queries the client device. Point cloud distribution system 100 may perform a lookup of the identified CPUs and GPUs to determine the number of points or primitives that the hardware resources are able to process and/or render in a given time (e.g., per second). Point cloud distribution system 100 may adjust the client device performance based on the availability of the identified resources. For instance, if 50% of the CPU and GPU cycles are occupied performing other tasks, point cloud distribution system 100 may reduce the client device performance associated with the identified CPU and GPU by half. In some other embodiments, point cloud distribution system 100 may directly determine (at 406) the client device performance by performing a test that measures the processing and/or rendering performance of the client device.

Process 400 includes determining (at 408) the visual characteristics that are supported by the client device. The visual characteristics supported by the client device may include the visual characteristics that are supported by the hardware and/or software used for rendering the point cloud. For instance, the GPU of the client device may support rendering all color values with reflectivity and specular effects based on encoded reflectivity and specular visual characteristic values. However, the GPU of the client device may not support rendering transparency effects based on encoded transparency visual characteristic values. Accordingly, in some embodiments, determining (at 408) the supported visual characteristics may include identifying the visual characteristics with hardware acceleration support (e.g., the visual characteristics that can be rendered directly on or by the GPU) and excluding the visual characteristics that are rendered by the CPU via software emulation. In some other embodiments, the requested point cloud may be generated and defined with visual characteristics that are supported by the newest generation of a device but that is also backwards compatible with older generation devices (e.g., newer generation 3D video game consoles and older generations of the same 3D video game consoles). The client device may represent one of the older generation devices that does not have the hardware and/or software support for rendering certain visual characteristics. In other words, the values for those certain visual characteristics may be ignored.

Process 400 includes selecting (at 410) a set of the optimized splats that encodes the determined (at 408) supported visual characteristics (and that excludes encoding of unsupported visual characteristics) for all views of the point cloud with the cumulative number of points, primitives, and/or data encoded in the selected set of the optimized splats being within the maximum number of points or primitives that the determined (at 406) client device performance is capable of processing and/or rendering at the particular frame rate. For instance, point cloud distribution system 100 determines the total number of points or primitives encoded with the supported visual characteristics that the client device is able to render at the particular frame rate based on the determined (at 406) client device performance, and selects (at 410) optimized splats for the supported visual characteristics in all views that collectively do not exceed the total number of points or primitives. Accordingly, point cloud distribution system 100 dynamically selects (at 410) different optimized splats to provide to client devices with different hardware and/or software resources resulting in different processing and/or rendering performance.

Process 400 includes providing (at 412) the selected (at 410) set of optimized splats to the client device. In some embodiments, providing (at 412) the selected (at 410) set of optimized splats includes granting a software application running on the client device access to the selected (at 410) set of optimized splats or transferring the selected (at 410) set of optimized splats to a rendering engine that generates a 3D visualization from the selected (at 410) set of optimized splats. In some other embodiments, providing (at 412) the selected (at 410) set of optimized splats includes loading the selected (at 410) set of optimized splats into memory of the client device for subsequent processing or rendering by one or more applications running on the client device.

Point cloud distribution system 100 may customize the optimize splat selection to prioritize the quality of certain visual characteristics over other visual characteristics when selecting the optimized splats to satisfy constraints associated with the monitored network performance or device performance. The prioritization involves providing optimized splats for higher priority visual characteristics with less data reduction and less quality loss than optimized splats for lower priority visual characteristics. In other words, point cloud distribution system 100 may select optimized splats that encode the higher priority visual characteristics with a greater number of points and primitives, and optimized splats that encode the lower priority visual characteristics with a lesser number of points and primitives such that the encoding of the higher priority visual characteristics more closely matches the original encoding of those visual characteristics in the original point cloud with less loss than the encoding of the lower priority visual characteristics.

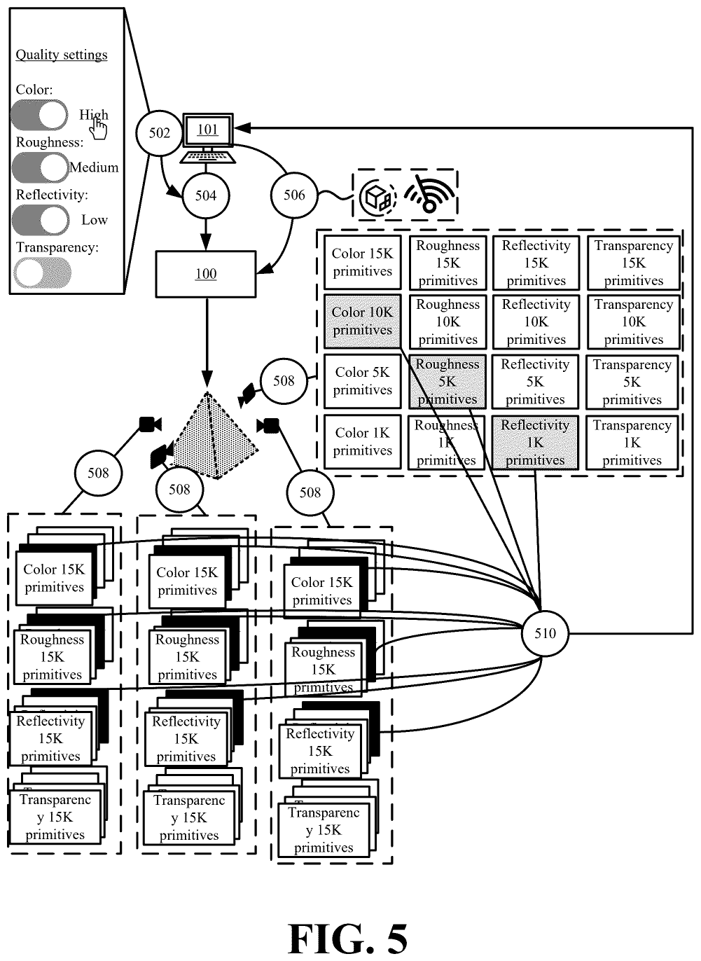

FIG. 5 illustrates an example of the adaptive distribution of optimized splats for a point cloud based on different prioritizations of the point cloud visual characteristics in accordance with some embodiments presented herein. Client device 101 receives (at 502) a prioritization for the visual characteristics of a point cloud. For instance, the point cloud may represent a 3D model or asset that is presented in a game or another application, and visual characteristics of the 3D model or asset may be customized.

In some embodiments, the prioritization is defined manually in response to user input. As shown in FIG. 5, an application may provide a configuration interface for prioritizing the different visual characteristics of the point cloud or a list of visual characteristics supported by various point cloud. The user may set the color visual characteristics to the highest priority, the roughness visual characteristic to a medium priority, the reflectivity visual characteristic to a low priority, and the transparency visual characteristic to a zero priority to exclude or disable the transparency visual characteristic from being included or encoded as part of the optimized splats.

In some other embodiments, the prioritization is defined automatically by client device 101 or an executing application. For instance, the executing application may analyze the rendering performance of client device 101, and may determine that the hardware resources of client device 101 accelerate the rendering of the color visual characteristics, accelerate the rendering of the roughness visual characteristic but that the roughness visual characteristic has less of an impact on the final rendering than the color visual characteristics, do not accelerate the rendering of the reflectivity visual characteristic which is instead rendering through slower software emulation, and that the transparency visual characteristic is not supported by client device 101, the rendering engine, or the executing application. Accordingly, the executing application may automatically set the different priorities for the different visual characteristics based on the analysis of the rendering performance.

Client device 101 requests (at 504) a lossy representation of the point cloud that is customized according to the received (at 502) prioritization of the visual characteristics. For instance, client device 101 generates and sends a request message that includes the prioritization listing or different prioritizes specified for the visual characteristics to point cloud distribution system 100.

Point cloud distribution system 100 may determine (at 506) the maximum amount of splat data or points and primitives that client device 101 is able to render at a given frame rate. In some embodiments, point cloud distribution system 100 may separately analyze the processing and/or rendering performance of client device 101 or may identify the hardware resources of client device 101 to determine (at 506) the maximum amount of splat data or points and primitives that client device 101 is able to render at the given frame rate. In some other embodiments, point cloud distribution system 100 selects the optimized splats based on the requested prioritization and without the separate performance analysis.

Point cloud distribution system 100 performs (at 508) a prioritized selection of optimized splats that minimizes the data reduction and quality loss for the optimized splats encoding the highest priority visual characteristics, that maximizes the data reduction and quality loss for the optimized splats encoding the lowest priority visual characteristics, and that results in a selected set of optimized splats that does not exceed the determined (at 506) maximum amount of splat data or points and primitives that client device 101 is able to render at the given frame rate. In other words, point cloud distribution system 100 selects optimized splats for the higher priority visual characteristics to encode more data and detail than the optimized splats that are selected for the lower priority visual characteristics.

As shown in FIG. 5, the set of selected optimized splats includes 12 optimized splats with the 12 optimized splats including 3 optimized splats for each of 4 different views of the point cloud. The 3 optimized splats for each view include an optimized splat for the color visual characteristics that is encoded with more data and less loss (e.g., more primitives and/or smaller primitives) than an optimized splat for the roughness characteristic, and the optimized splat for the roughness visual characteristic is encoded with more data and less loss than an optimized splat for the reflectivity visual characteristic. For instance, the optimized splats for the color visual characteristics in each view may be defined with 10,000 primitives and 5 Mb of data, the optimized splats for the roughness characteristics may be defined with 5,000 primitives and 3 Mb of data, and the optimized splats for the reflectivity visual characteristic may be defined with 1,000 primitives and 1 Mb of data. The resulting selection satisfies the specified prioritization while maximizing the amount of data that client device 101 is able to render for each visual characteristics given the client device's 101 rendering performance.

Client device 101 receives (at 510) the set of selected optimized splats that encode different visual characteristics with different amounts of data based on the specified prioritization, and generates a complete 3D representation of the original point cloud with variable loss for the different visual characteristics from the received (at 510) set of selected optimized splats. Specifically, client device 101 renders a visualization for each view based on the optimized splats that provide a variable lossy encoding of the visual characteristics for the exposed features or surfaces in that view, and client device 101 combines the visualization that is generated for each view to produce the cohesive 360-degree or complete 3D visualization for the objects or scenes of the original point cloud. Since the optimized splats encode different numbers of primitives with different shapes and sizes at different positions, client device 101 may use an interpolated rendering technique to generate the visualization for each view and the combined final 3D representation of the point cloud.

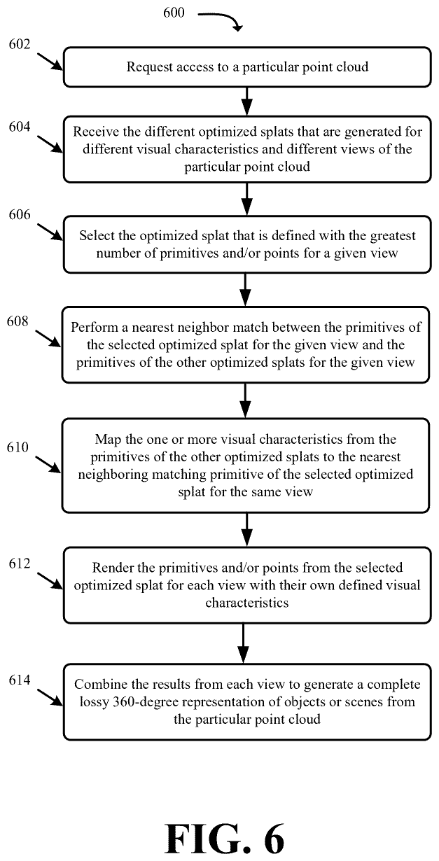

FIG. 6 presents a process 600 for rendering a 3D visualization from different sets of optimized splats that are encoded with different amounts of data for different visual characteristics in the same views in accordance with some embodiments presented herein. Process 600 is implemented by client device 101.

Client device 101 may include a device that generates 3D visualizations or graphics from the optimized splats. Client device 101 may be a computer, laptop, tablet, smartphone, or other user device with 3D rendering capabilities. In some embodiments, client device 101 is a gaming console or appliance for rendering and playing 3D games or a streaming device for watching 3D movies, animations, or other visualizations.

Process 600 includes requesting (at 602) access to a particular point cloud. The request may include an identifier of the particular point cloud, a prioritization of the visual characteristics, and/or identifiers for hardware resources of client device 101.

Process 600 includes receiving (at 604) the different optimized splats that are generated for different visual characteristics and different views of the particular point cloud. For instance, the device may receive (at 604) a first optimized splat with a first set of primitives that are defined with a first visual characteristic (e.g., color) for a first view of the particular point cloud, a second optimized splat with a different second set of primitives that are defined with a second visual characteristic (e.g., roughness, transparency, or reflectivity) for the first view of the particular point cloud, a third optimized splat with a third set of primitives that are defined with the first visual characteristic for a second view of the particular point cloud, and a fourth optimized splat with a fourth set of primitives that are defined with the second visual characteristic for the second view of the particular point cloud. Collectively, the received set of optimized splats representing a lossy encoding for all visible points, features, or surfaces of the particular point cloud.

Process 600 includes selecting (at 606) the optimized splat that is defined with the greatest number of primitives and/or points for each view. The selected (at 606) optimized splat corresponds to the optimized splat with the highest resolution for the given view and/or the most detail. In some embodiments, point cloud distribution system 100 may send the positions (e.g., x, y, and z coordinates) of the original points from the requested point cloud without the original visual characteristics to client device 101 in addition to the set of optimized splats, and the selection (at 606) may include selecting the original point cloud points that are within the given view. In some such embodiments, client device 101 maps the visual characteristics from the reduced set of primitives in the optimized splats to the original set of points.

Process 600 includes performing (at 608) a nearest neighbor match between the primitives of the selected (at 606) optimized splat for each view and the primitives of the other optimized splats for the same view. The nearest neighbor match identifies which primitives or points from the other less-dense optimized splats are closest to which primitives or points from the selected (at 606) more-dense optimized splat when the primitives or points defined for the different optimized splats of the same view (e.g., optimized splats encoding different visual characteristics for the same view with different reduced sets of primitives) are positional misaligned or offset. In some cases, two or more primitives from the higher resolution selected (at 606) optimized splat may be nearest neighbor matches for a single primitive from a lower resolution optimized splat.

In some embodiments, the nearest neighbor matching is performed via tree traversals. In some such embodiments, each optimized splat may be represented as a K-Dimensional (KD) tree or other tree structure (e.g., binary tree, octree, etc.) with the nodes at different layers of the tree representing different regions of the 3D space encompassed by the optimized splat and with the leaf nodes of the tree corresponding to one or more primitives. The nearest neighbor matching may therefore involve traversing down the different paths or branches of each tree representing the different optimized splat, and identifying the leaf nodes or primitives that are defined within each tree for corresponding regions of space.

Process 600 includes mapping (at 610) the one or more visual characteristics from the primitives of the other optimized splats to the nearest neighboring matching primitive of the selected (at 606) optimized splat for the same view. For instance, the optimized splat with the highest resolution for a given view may be defined with only a transparency non-positional element. Color, reflectivity, roughness, and other visual characteristics that have a lower variance or greater commonality in that given view are then mapped and assigned to the primitives of the highest resolution optimized splat from primitives of the other optimized splats created for the given view based on the nearest neighbor matching. In some cases, the mapping may include assigning the same visual characteristic from a single primitive of a lower resolution optimized splat to two or more nearest neighbor matching primitives of the selected (at 606) highest-resolution optimized splat. A similar mapping (at 610) based on the nearest neighbor matching may be performed when the positions of the original points are received without all or some of the visual characteristics that are stored in the optimized splats. The mapping (at 610) results in the points and/or primitives from the selected (at 606) optimized splat of each view being defined with values for the visual characteristics that were selected for rendering or all visual characteristics of the original point cloud.

Process 600 includes rendering (at 612) the primitives and/or points from the selected (at 606) optimized splat for each view with their own defined visual characteristics and the mapped (at 610) visual characteristics of the other optimized splats, and combining (at 614) the results from each view to generate a complete lossy 360-degree representation of objects or scenes from the particular point cloud. Specifically, each of the selected (at 606) optimized splats produces a visualization for a different part of the complete 3D visualization, and combining (at 614) the results includes stitching the visualizations seamlessly together to present the 3D visualization. In some embodiments, the optimized splats for each view are associated with an identifier that identifies a position in the 3D space of the particular point cloud from which the view is captured or generated. Using the identifier, the device is able to correctly position each of the visualizations relative to one another in a 3D space to recreate the complete 3D visualization.

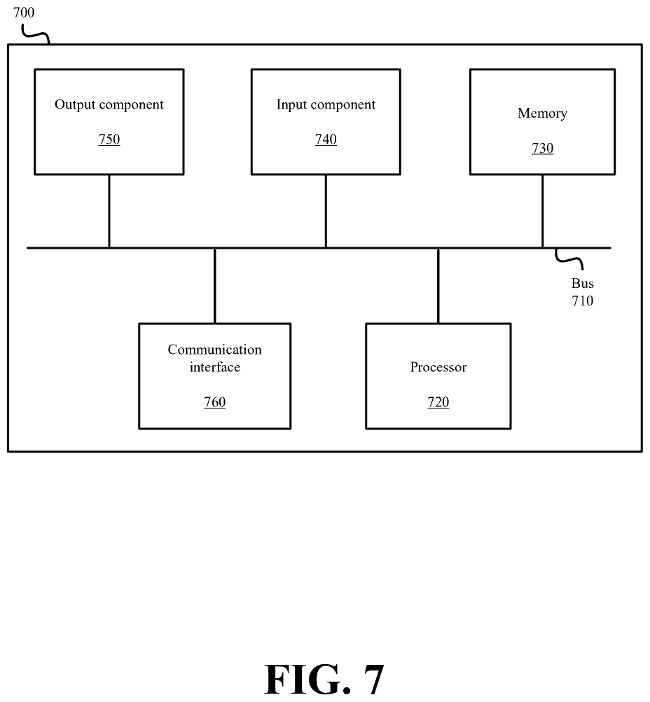

FIG. 7 is a diagram of example components of device 700. Device 700 may be used to implement one or more of the tools, devices, or systems described above (e.g., point cloud distribution system 100, client device 101, etc.). Device 700 may include bus 710, processor 720, memory 730, input component 740, output component 750, and communication interface 760. In another implementation, device 700 may include additional, fewer, different, or differently arranged components.

Bus 710 may include one or more communication paths that permit communication among the components of device 700. Processor 720 may include a processor, microprocessor, or processing logic that may interpret and execute instructions. Memory 730 may include any type of dynamic storage device that may store information and instructions for execution by processor 720, and/or any type of non-volatile storage device that may store information for use by processor 720.

Input component 740 may include a mechanism that permits an operator to input information to device 700, such as a keyboard, a keypad, a button, a switch, etc. Output component 750 may include a mechanism that outputs information to the operator, such as a display, a speaker, one or more LEDs, etc.

Communication interface 760 may include any transceiver-like mechanism that enables device 700 to communicate with other devices and/or systems. For example, communication interface 760 may include an Ethernet interface, an optical interface, a coaxial interface, or the like. Communication interface 760 may include a wireless communication device, such as an infrared (IR) receiver, a Bluetooth® radio, or the like. The wireless communication device may be coupled to an external device, such as a remote control, a wireless keyboard, a mobile telephone, etc. In some embodiments, device 700 may include more than one communication interface 760. For instance, device 700 may include an optical interface and an Ethernet interface.

Device 700 may perform certain operations relating to one or more processes described above. Device 700 may perform these operations in response to processor 720 executing software instructions stored in a computer-readable medium, such as memory 730. A computer-readable medium may be defined as a non-transitory memory device. A memory device may include space within a single physical memory device or spread across multiple physical memory devices. The software instructions may be read into memory 730 from another computer-readable medium or from another device. The software instructions stored in memory 730 may cause processor 720 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations.

The actual software code or specialized control hardware used to implement an embodiment is not limiting of the embodiment. Thus, the operation and behavior of the embodiment has been described without reference to the specific software code, it being understood that software and control hardware may be designed based on the description herein.

For example, while series of messages, blocks, and/or signals have been described with regard to some of the above figures, the order of the messages, blocks, and/or signals may be modified in other implementations. Further, non-dependent blocks and/or signals may be performed in parallel. Additionally, while the figures have been described in the context of particular devices performing particular acts, in practice, one or more other devices may perform some or all of these acts in lieu of, or in addition to, the above-mentioned devices.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, while some devices are shown as communicating with a network, some such devices may be incorporated, in whole or in part, as a part of the network.

To the extent the aforementioned embodiments collect, store or employ personal information provided by individuals, it should be understood that such information shall be used in accordance with all applicable laws concerning protection of personal information. Additionally, the collection, storage and use of such information may be subject to consent of the individual to such activity, for example, through well-known “opt-in” or “opt-out” processes as may be appropriate for the situation and type of information. Storage and use of personal information may be in an appropriately secure manner reflective of the type of information, for example, through various encryption and anonymization techniques for particularly sensitive information.

Some implementations described herein may be described in conjunction with thresholds. The term “greater than” (or similar terms), as used herein to describe a relationship of a value to a threshold, may be used interchangeably with the term “greater than or equal to” (or similar terms). Similarly, the term “less than” (or similar terms), as used herein to describe a relationship of a value to a threshold, may be used interchangeably with the term “less than or equal to” (or similar terms). As used herein, “exceeding” a threshold (or similar terms) may be used interchangeably with “being greater than a threshold,” “being greater than or equal to a threshold,” “being less than a threshold,” “being less than or equal to a threshold,” or other similar terms, depending on the context in which the threshold is used.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

1. A method comprising:
receiving a request to access a point cloud from a client device, the point cloud comprising a plurality of points that are distributed across a three-dimensional (3D) space to generate a 3D model, wherein each point of the plurality of points is defined with a position in the 3D space and a plurality of visual characteristics that are presented at the position;
determining one or more performance parameters that limit an amount of point cloud data that the client device is able to receive or process in a given time;
selecting different sets of optimized splats for different views of the point cloud that satisfy the one or more performance parameters based on a cumulative amount of data encoded within the different sets of optimized splats being equal to or less than the amount of point cloud data that the client device is able to receive or process in the given time, wherein each set of optimized splats from the different sets of optimized splats comprises at least a first optimized splat corresponding to a first lossy encoding of a first visual characteristic from the plurality of visual characteristics defined for a set of points from the plurality of points in a particular view from the different views and a second optimized splat corresponding to a second lossy encoding of a second visual characteristic from the plurality of visual characteristics defined for the set of points; and
providing the different sets of optimized splats to the client device in response to the request to access the point cloud.

2. The method of claim 1, wherein determining the one or more performance parameters comprises:
monitoring a performance of a network path that establishes network connectivity to the client device; and
determining the amount of point cloud data that the client device is able to receive or process in the given time based on the performance of the network path.

3. The method of claim 1, wherein determining the one or more performance parameters comprises:
identifying one or more hardware resources of the client device used to render the point cloud; and
determining the amount of point cloud data that the client device is able to receive or process in the given time based on a rendering performance associated with the one or more hardware resources.

4. The method of claim 1 further comprising:
retrieving a different plurality of optimized splats that have been generated for each view of the different views, wherein the different plurality of optimized splats that have been generated for the particular view comprises the first optimized splat and the second optimized splat in the different sets of optimized splats, a third optimized splat corresponding to a different lossy encoding of the first visual characteristic than the first optimized splat, and a fourth optimized splat corresponding to a different lossy encoding of the second visual characteristic than the second optimized splat.

5. The method of claim 4, wherein selecting the different sets of optimized splats comprises:
determining that the third optimized splat and the fourth optimized splat contain data that is in excess of the amount of point cloud data that the client device is able to receive or process in the given time for the particular view; and
determining that the first optimized splat and the second optimized splat contain data that the client device is able to receive or process in the given time for the particular view.

6. The method of claim 4,
wherein the first optimized splat encodes the first visual characteristic to a first reduced set of primitives that encompass the position of each point in the set of points with fewer primitives than points in the set of points; and
wherein the third optimized splat encodes the first visual characteristic to a second reduced set of primitives that has more primitives and primitives of different shapes and sizes than primitives of the first reduced set of primitives.

7. The method of claim 1, wherein providing the different sets of optimized splats comprises:
streaming the different sets of optimized splats over a data network to the client device without streaming data associated with each point of the plurality of points.

8. The method of claim 1, wherein providing the different sets of optimized splats comprises:
distributing the different sets of optimized splats to a rendering engine of the client device for generation of a lossy 3D representation of the 3D model.

9. The method of claim 1 further comprising:
receiving a list of visual characteristics that are supported by the client device; and
wherein selecting the different sets of optimized splats comprises:
including one optimized splat from a plurality of optimized splats that encodes at least one visual characteristic from the list of visual characteristics in each view of the different views as part of the different sets of optimized splats; and
excluding, from the different sets of optimized splats, any optimized splat from the plurality of optimized splats that encodes a visual characteristic not in the list of visual characteristics.

10. The method of claim 1 further comprising:
receiving a prioritized list of visual characteristics that provides a higher priority to the first visual characteristic than the second visual characteristic; and
wherein selecting the different sets of optimized splats comprises:
selecting the first optimized splat that encodes the first visual characteristic with less data reduction and quality loss than the second optimized splat encoding of the second visual characteristic based on the prioritized list of visual characteristics.

11. The method of claim 1, wherein selecting the different sets of optimized splats comprises:
adjusting an amount of data reduction that is associated with each optimized splat in the different sets of optimized splats based on the one or more performance parameters.

12. The method of claim 1, wherein the plurality of visual characteristics comprise two or more of a color visual characteristic, a roughness visual characteristic, a reflectivity visual characteristic, and a transparency visual characteristic.

13. The method of claim 1, wherein the first optimized splat comprises a single primitive that replaces a definition of two or more points from the set of points having a common value for the first visual characteristic, and wherein the single primitive is defined with the common value for the first visual characteristic.

14. A distribution system comprising:
one or more hardware processors configured to:
receive a request to access a point cloud from a client device, the point cloud comprising a plurality of points that are distributed across a three-dimensional (3D) space to generate a 3D model, wherein each point of the plurality of points is defined with a position in the 3D space and a plurality of visual characteristics that are presented at the position;
determine one or more performance parameters that limit an amount of point cloud data that the client device is able to receive or process in a given time;
select different sets of optimized splats for different views of the point cloud that satisfy the one or more performance parameters based on a cumulative amount of data encoded within the different sets of optimized splats being equal to or less than the amount of point cloud data that the client device is able to receive or process in the given time, wherein each set of optimized splats from the different sets of optimized splats comprises at least a first optimized splat corresponding to a first lossy encoding of a first visual characteristic from the plurality of visual characteristics defined for a set of points from the plurality of points in a particular view from the different views and a second optimized splat corresponding to a second lossy encoding of a second visual characteristic from the plurality of visual characteristics defined for the set of points; and
provide the different sets of optimized splats to the client device in response to the request to access the point cloud.

15. The distribution system of claim 14, wherein determining the one or more performance parameters comprises:
monitoring a performance of a network path that establishes network connectivity to the client device; and
determining the amount of point cloud data that the client device is able to receive or process in the given time based on the performance of the network path.

16. The distribution system of claim 14, wherein determining the one or more performance parameters comprises:
identifying one or more hardware resources of the client device used to render the point cloud; and
determining the amount of point cloud data that the client device is able to receive or process in the given time based on a rendering performance associated with the one or more hardware resources.

17. The distribution system of claim 14, wherein the one or more hardware processors are further configured to:
retrieve a different plurality of optimized splats that have been generated for each view of the different views, wherein the different plurality of optimized splats that have been generated for the particular view comprises the first optimized splat and the second optimized splat in the different sets of optimized splats, a third optimized splat corresponding to a different lossy encoding of the first visual characteristic than the first optimized splat, and a fourth optimized splat corresponding to a different lossy encoding of the second visual characteristic than the second optimized splat.

18. The distribution system of claim 14, wherein the one or more hardware processors are further configured to:
receive a list of visual characteristics that are supported by the client device; and
wherein selecting the different sets of optimized splats comprises:
including one optimized splat from a plurality of optimized splats that encodes at least one visual characteristic from the list of visual characteristics in each view of the different views as part of the different sets of optimized splats; and
excluding, from the different sets of optimized splats, any optimized splat from the plurality of optimized splats that encodes a visual characteristic not in the list of visual characteristics.

19. The distribution system of claim 14, wherein the one or more hardware processors are further configured to:
receive a prioritized list of visual characteristics that provides a higher priority to the first visual characteristic than the second visual characteristic; and
wherein selecting the different sets of optimized splats comprises:
selecting the first optimized splat that encodes the first visual characteristic with less data reduction and quality loss than the second optimized splat encoding of the second visual characteristic based on the prioritized list of visual characteristics.

20. A non-transitory computer-readable medium storing instructions that, when executed by one or more processors of a distribution system, cause the distribution system to perform operations comprising:
receiving a request to access a point cloud from a client device, the point cloud comprising a plurality of points that are distributed across a three-dimensional (3D) space to generate a 3D model, wherein each point of the plurality of points is defined with a position in the 3D space and a plurality of visual characteristics that are presented at the position;
determining one or more performance parameters that limit an amount of point cloud data that the client device is able to receive or process in a given time;
selecting different sets of optimized splats for different views of the point cloud that satisfy the one or more performance parameters based on a cumulative amount of data encoded within the different sets of optimized splats being equal to or less than the amount of point cloud data that the client device is able to receive or process in the given time, wherein each set of optimized splats from the different sets of optimized splats comprises at least a first optimized splat corresponding to a first lossy encoding of a first visual characteristic from the plurality of visual characteristics defined for a set of points from the plurality of points in a particular view from the different views and a second optimized splat corresponding to a second lossy encoding of a second visual characteristic from the plurality of visual characteristics defined for the set of points; and
providing the different sets of optimized splats to the client device in response to the request to access the point cloud.
